(19) United States
(12) Patent Application Publication
(10) Pub. No.: US 2013/0334309 A1
(43) Pub. Date: Dec. 19, 2013

(54) Method and system for selling items to be worn

(71) Applicant: HOINTER, INC., Seattle, WA (US)

(72) Inventors: Nadia Shouraboura, Seattle, WA (US); Caroline Shouraboura, Seattle, WA (US)

(73) Assignee: Hointer, Inc., Seattle, WA (US)

(21) Appl. No.: 13/815,855

(22) Filed: Mar. 15, 2013

Related U.S. Application Data
(60) Provisional application No. 61/660,767, filed on Jun. 17, 2012.
(60) Provisional application No. 61/714,189, filed on Oct. 15, 2012.

(51) Int. Cl. G06Q 10/08

(52) U.S. Cl. CPC G06Q 10/087
USPC 235/385

(57) ABSTRACT

Embodiments of the present invention relate to a system and method for beginning and completing a physical store transaction for an item, or items, to be worn. The transaction is directed by a purchaser using in-store indicators, request windows, electronic devices and/or by an act of moving unique identifiers, attached to items to be worn, electronic devices or the purchaser.

The computing system receives purchaser's requests, combines purchaser information, which may include but is not limited to identification of the purchaser, purchaser's preferences and payment information, and returns information to the purchaser, directs the movement of product within the store, and/or completes purchase transactions.

The purchaser may complete the buying of the product by walking to the store, taking the item he/she needs and walking out of the store with no additional action (zero-action).

### CROSS REFERENCE TO RELATED APPLICATION(S)

This application is related to U.S. Patent Application No. 61/660,767, filed Jun. 17, 2012, entitled “METHOD AND SYSTEM FOR SELLING ITEMS TO BE WORN;” which is incorporated herein in its entirety by reference, and to U.S. Patent Application No. 61/714,169, filed Oct. 15, 2012, entitled “EXPEDITED TRANSACTIONS RELATED TO APPAREL,” which is incorporated herein in its entirety by reference.

### BACKGROUND

Purchase decisions for clothing and other items to be worn (“apparel”) today are made either on-line, over the Internet (“e-commerce”), or in physical stores (“brick and mortar”).

### BRIEF DESCRIPTION OF THE DRAWINGS

FIG. 1 is a perspective schematic view of a purchasing establishment configured in accordance with an embodiment of the disclosure.

FIG. 2 illustrates an example display of indicators associated with an item.

FIG. 3 illustrates an example of indicators and request windows in a changing space configured in accordance with an embodiment of the disclosure.

FIG. 4 is a block diagram of a computing system that manages operations of a purchasing establishment configured in accordance with an embodiment of the disclosure.

FIG. 5 is a flow diagram of a routine that enables single-action or zero-action shopping for recognized customers in accordance with an embodiment of the disclosure.

FIG. 6 is a flow diagram of a routine to process a purchaser's “Buy” request in accordance with an embodiment of the disclosure.

FIG. 7 is a flow diagram of a routine to process a purchaser's “Try” request in accordance with an embodiment of the disclosure.

FIG. 8 is a flow diagram of a routine to implement a purchaser's requests in the fitting room in accordance with an embodiment of the disclosure.

### DETAILED DESCRIPTION

Technology is disclosed for selling apparel by creating a purchasing experience that applies the efficiency of online shopping to a physical store, using displays with items and indicators, electronic devices with the capability to identify customers and interact with indicators, a large selection of items housed on location that may be delivered to the customer directly into a changing space for trial, and single-action and zero-action purchase.

The inventor has determined that conventional purchasing of apparel, at retail or department stores, is deficient and creates an unfavorable experience for the purchaser. A purchaser of apparel can lack the knowledge of whether the brick and mortar store's limited inventory includes the purchaser's desired size or style prior to making the trip to and through the store. Such stores often place unnecessary amounts of inventory on the shop floor. This subjects the purchaser to endure searching sizable piles of apparel or browsing lengthy racks of crammed hangers in search of the item hoped for. If the purchaser is lucky enough to find the desired item in the proper size and, style then the trip to the changing room can also be an unfavorable experience. The purchaser must lug the items to the fitting room and wait for a room to become available. Once inside, and after making the effort to undress and try on the desired items, the customer may discover the need for a different size in the fitting room. This requires a modest customer to get dressed again, leave the changing room, find a place to store any items to be retained for purchasing, and make a second trip to retrieve a different size, all while lugging any items that could not be stored. If and when the purchaser does make a purchase the wait at the checkout line can be long and embarrassing if the customer's purchase card is declined.

When returning an item, the customer typically must find the receipt, return to the store, navigate the maze that is the store's layout, stand in line at customer service and confront a customer service person; all without the guarantee that the customer's item will even be accepted for return.

While innovations allowing for the online purchasing of apparel or other articles to be worn improve the convenience of the purchase process, these approaches suffer from the purchaser's inability to physically touch and feel the quality of the item, and prevent the purchaser from trying on the item(s) prior to purchasing the item(s). After waiting many days or even weeks for delivery, there exists a substantial risk that the item(s) can either be damaged or cannot satisfy the purchaser due to poor quality, improper size, or the wrong item(s) having been sent.

When returning an item bought online, customers are typically responsible for return shipping. Thus, even if a customer gets a full refund, which may take days, they still suffer from the loss of time and money.

There is a better way.

A purchaser, as used in this document, is a person or entity that is able to make a purchase or a rental agreement with any purchasing establishment, with illustrative reference to establishments offering apparel.

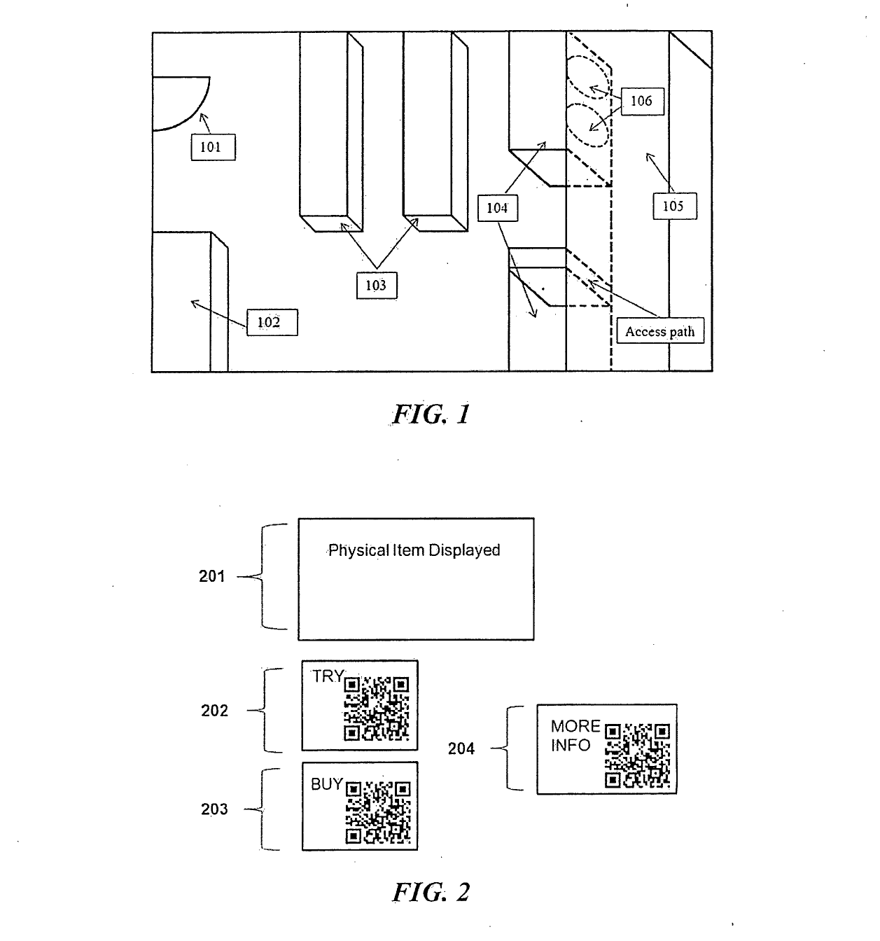

FIG. 1 is a perspective schematic view of a purchasing establishment configured in accordance with an embodiment of the disclosure. In various embodiments, the purchasing establishment comprises one or more displays, items to be worn, indicators (for example, purchase indicators, try indicators, information indicators, checkout indicators, etc.), unique identifiers for different elements in the store (for example, for items to be worn, for electronic devices, for purchasers, for totes, for bags, etc.), changing spaces, request windows, service areas, electronic devices, arrays of readers, and a computing server system.

The purchasing establishment's layout can be rearranged to optimize the amount of time that a purchaser spends in the store.

In FIG. 1 element 101 represents a door and element 102 represents a drop off for returning items.

In the illustrated embodiment, displays 103 have apparel items and indicators. The displays' function is to house and present to the purchaser item(s) to be worn. Apparel items have specific apparel-related features, e.g., size, color, style, etc. Individual feature specific items are apparel items having particular specific apparel-related features. All feature specific items to be worn can contain a unique identifier by electronic or non-electronic means, such as a radio frequency identification tag (“RFID”) or an optical RFID (“OPID”). Unique identifiers may be attached to other elements in the store.

A changing space 104 includes fitting rooms with request windows and indicators. In various embodiments, fitting rooms have means of providing and securing privacy to the purchaser while trying on feature specific items to be worn and also have means to secure desired items until ready for checkout.

Element 105 represents a service room with access to the shop floor. The area can house an inventory of feature specific items to be worn.

Element 106 are request windows, that in the illustrated embodiment allow the purchaser to exchange item(s) with the service room and enabling the service room to deliver item(s) to the purchaser.

FIG. 2 illustrates an example display of indicators associated with an item.

In various embodiments, in the vicinity of, next to, or affixed on or in the items) to be worn 201 there exist one or more purchase indicators 203. In some embodiments, a purchase indicator appears in an electronic device, e.g., a device configured to scan or otherwise recognize an item. The purchase indicator is or includes a pattern or sequence of visual or nonvisual information that by itself or with the aid of electronic and/or non-electronic device(s), e.g., bar codes, radio frequency identifiers (RFID), near field communications (NFC), QR codes or Braille, informs the purchaser of the option to purchase.

In some embodiments, also in the vicinity of, next to, or affixed on or in the item(s) to be worn there exist one or more try indicators 202. In some embodiments, a purchase indicator appears in an electronic device. The try indicator is or includes a pattern or sequence of visual or nonvisual information that by itself or with the aid of electronic and/or non-electronic device(s), e.g., bar codes, RFID, NFC, QR codes or Braille, informs the purchaser of the option to try on the item(s) to be worn.

In some embodiments, also in the vicinity of, next to, or affixed on the item(s) to be worn there exist one or more information indicators (element 204). In some embodiments, a purchase indicator appears in an electronic device. The information indicator is or includes a pattern or sequence of visual or nonvisual information that by itself or with the aid of electronic and/or non-electronic device(s), e.g., bar codes, RFID, NFC, QR codes or Braille, informs the purchaser of the option to receive additional information about the item(s) to be worn. Such information may include but is not limited to size availability, color availability, price, material content, origin of the item and its components, care instructions, suggested accessories, others who also wore or purchased the item, multimedia (fashion shows featuring the item), consumer reviews, durability/longevity, value rating, etc.

The displayed apparel item may have other indicators (for example, size, color, checkout, etc.).

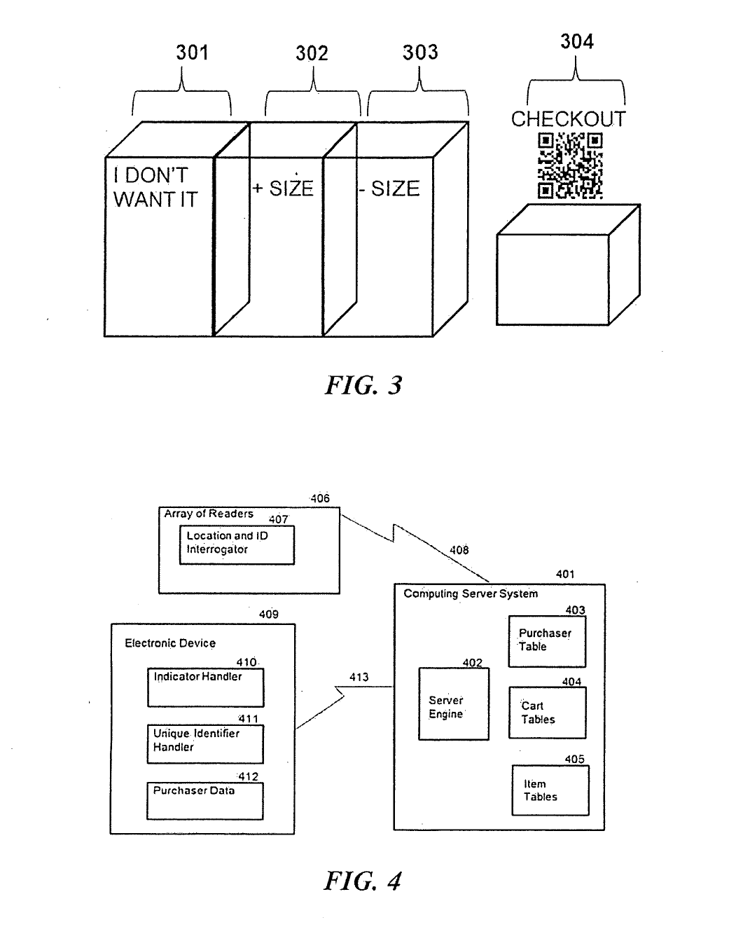

FIG. 3 illustrates indicators and request windows in a fitting room such as changing space 104 in FIG. 1.

In some embodiments, in the fitting room there exist one or more request windows. The window informs the purchaser of an option to place an item in the request window, for example, to return an unwanted item 301 or to request a larger size 302 or smaller size 303 of the same item. In some embodiments, the request window has means for a one-way or two-way access from the service area to the fitting room to allow purchaser to receive feature specific item(s) from the service area and to return unwanted feature specific items to the service area.

Also in the vicinity of there may exist one or more indicators (for example, a checkout indicator 304), or a size and/or color indicator. The checkout indicator is or includes a pattern or sequence of visual or nonvisual information that by itself or with the aid of electronic and/or non-electronic device(s), e.g., bar codes, RFID, NFC, QR codes or Braille, informs the purchaser of the option to complete his/her purchase. In some embodiments, a checkout indicator appears in an electronic device.

FIG. 4 is a block diagram of a computing system that manages operations of a purchasing establishment configured in accordance with an embodiment of the disclosure. In some embodiments, the computing server system 401 includes one or more computers used to perform services requested by purchasers and the operators of the purchasing establishment. The computing server system may be placed in multiple locations, including but not limited to the purchasing establishment itself, other purchasing establishments, separate dedicated facilities, and cloud computing providers. In the illustrated embodiment, the computing server system has a Server Engine (element 402) and optional Purchaser Tables 403, Cart Tables 404 and Item Tables 405.

Element 406 represents one or more readers (“array(s) of readers”) 407. In the illustrated embodiment, the array(s) of readers includes Location and ID Interrogators.

The array(s) Of readers' function is to read unique identifiers attached to elements in the, store (for example, unique identifiers for item(s) to be worn, electronic devices, totes, bags, etc) 409 and, e.g., by means of a wired or wireless connection .408 to the purchasing establishment's computing server system 401, communicate the location of the store elements.

Electronic device(s) 409 may be, e.g., a tablet computer, smartphone, or other miniaturized computing device. Electronic devices may be self-owned by purchasers entering the purchasing establishment. Electronic devices may be owned by the purchasing establishment and loaned to purchasers upon entering the purchasing establishment. The electronic device can have several possible functions, with the possibility of performing any combination of the functions.

One function can be to interpret the pattern or sequence of information actively or passively transmitted by the indicators 410.

Another function can be to interpret the unique identifier on items to be worn 411.

Another function can be to access, communicate with and display communications from the purchasing establishment's computing server system 401.

Another function can be to transmit a location tracking signal (e.g., GPS, RFID or LIPID, Wi-Fi, Bluetooth, and other EM signals) to an array of readers 409 located throughout the purchasing establishment.

Another function can be to signal, including but not limited to generating audible and vibration signals (e.g., to indicate proximity to a purchasing establishment location).

Another function can be to have the means to allow the purchaser to provide and authenticate his or her account (e.g., by scanning a purchaser's unique physical feature of, on, or in the purchaser's body or subcutaneous wireless transmitter (e.g, RFID tag), by unique electronic tokens stored on the device, or by a conventional username and password).

Another function can be to access a purchaser's account information 412 to complete any sales transaction initiated by the purchaser. The profile may also include purchase history, shipping info, carts (shopping/wish), coupons/rewards, etc.

Electronic devices may communicate 413 with the Computing Server System 401.

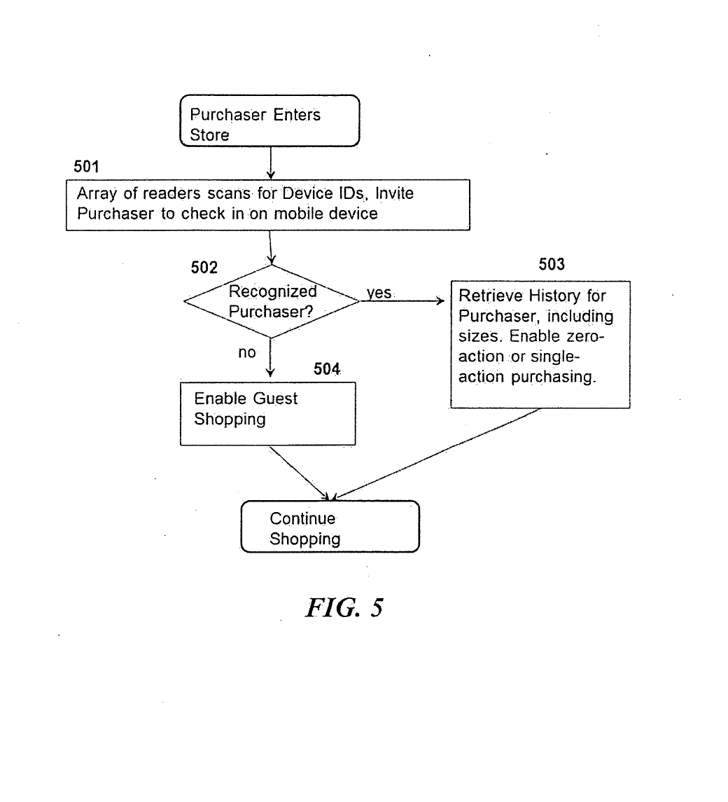

FIG. 5 is a flow diagram of a routine that enables single-action or zero-action shopping for recognized customers in accordance with an embodiment of the disclosure. In some embodiments, purchasers entering the purchasing establishment may possess self-owned electronic devices. In some embodiments, upon entering a purchasing establishment the purchaser can have the option of being loaned an electronic device.

At block 501, when a purchaser enters the store in the illustrated embodiment; the computing system attempts to identify the purchaser by scanning for Device IDs and/or offers customers to login to their accounts. The purchaser's account can be created by the purchaser providing an authenticated unique identifier to the purchasing establishment's computing server system. The identifier may be transmitted through action by the purchaser or with zero-action transmittal automatically from the purchaser's electronic device. Such unique identifiers may include, but are not limited to, e.g., conventional username/password combinations, social media IDs, email IDs, and electronic tokens stored on the electronic device. At block 502, if the purchaser is recognized, the server system may authenticate the unique ID using standard authentication methods appropriate to the particular ID provided, and assign an account. Once the account is created various types of data would be collected. The purchaser's account may include information such as: body sizes, body dimensions, purchase history, purchasing accounts, style preferences, medical information (e.g., for diabetic socks or orthopedic devices), sport activities, social media, significant holidays (e.g., anniversary, prom, wedding, honeymoon or vacation), etc. (element 503).

At block 503, the system enables single-action and zero-action shopping for a recognized purchaser and at block 504 the system may create a guest account for non-recognized purchaser. In an embodiment of the invention, zero-action purchase or rejection of item(s) can be accomplished by a purchaser as a by-product of their location in the purchasing establishment.

Various embodiments of the disclosure are expected to enable types of purchasing of item(s) to be worn: for example, one type offers the quickest experience of buying item(s) without trying them on; and another offers purchasers to try on item(s) of various sizes before purchasing them. Purchasers have the option of combining those experiences and buying some item(s) without trying them on, while buying others after trying them on.

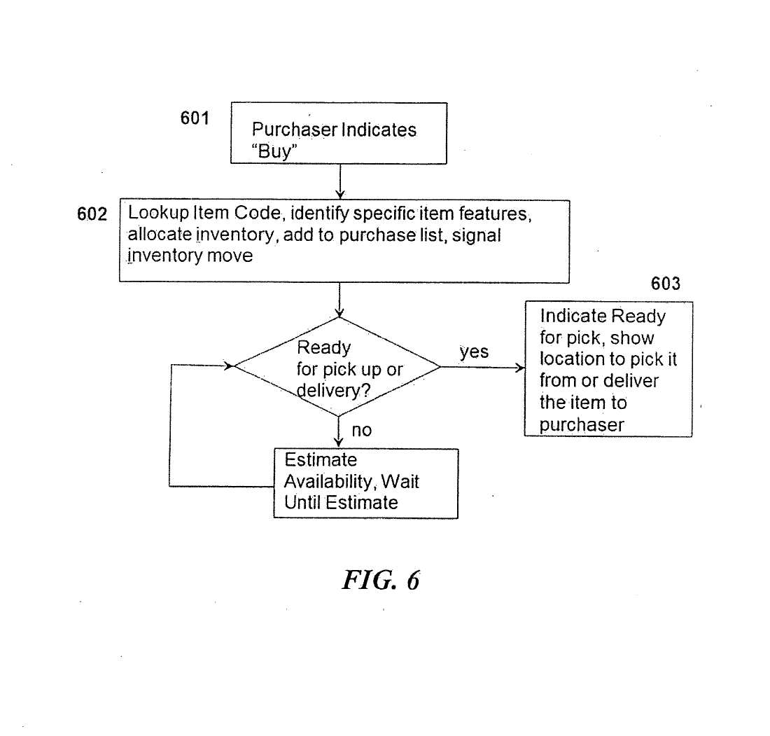

### A. Buying Without Trying Items on (FIG. 6)

FIG. 6 is a flow diagram of a routine to process a purchaser's “Buy” request in accordance with an embodiment of the disclosure. The purchaser can search the displays and arrive at an item of interest.

If the purchaser seeks to acquire more information about an item in a display he or she may interact with the information indicator to get more, information about the item. For example, she/he can use the loaned electronic device, an electronic device next to the item, or his/her own electronic device, if similarly capable, (e.g., device 409 of FIG. 4) to scan the information indicator. Once scanned the purchasing establishment's computing system can retrieve information about the scanned item and present the information to the purchaser on the electronic device.

If this purchaser is recognized by the system and decides to purchase the item(s) he/she can indicate so by taking the item off the shelf.

At block 601, if this purchaser decides to purchase the item(s) he/she can indicate so by interacting with the purchase indicator. One skilled in the art would appreciate that the interaction of purchasers with indicators may be implemented using various techniques. For example, the purchaser may scan the indicator with the electronic device or touch the indicator.

If the purchaser is identified and has historical purchasing data then the purchaser's data (for example, preferred size, style, color, etc.) can be retrieved from the purchasing establishment's computing system. If the feature specific items corresponding to an item's scanned purchase indicator are in stock, then the computing system can charge the payment method on file and complete the ordering transaction.

The purchaser may have an option to pick the item off the store shelf, or at designated counter, or have the items brought to the purchaser by store personnel or delivered at a later time to purchaser's preferred mailing address.

If the purchaser's account lacks historical purchasing data required for the feature specific item to be purchased, then the purchaser will be prompted for more specific features of the desired item (for example, the purchaser's dimensions, size, preferred style, color, etc.). This data can be stored in the purchaser's account in the purchasing establishment's computing system.

At block 602, once a purchaser has indicated the desired item(s) and specified the desired features of the item the purchasing establishment's computing system can search for the availability of the feature specific item(s) in inventory.

If the feature specific items corresponding to an item's scanned purchase indicator are in stock then as the purchase indicator is scanned they can be virtually added into a purchaser's account's electronic shopping cart. If the item is available on the shelf the system may indicate so to the purchaser. If it is only available in the service room, the system signals to gather the item in the service area. Gathering the requested item may be performed by employees or by an automated stock management and retrieval system.

If the feature specific items are not in stock then the electronic system may suggest an alternative feature specific items that are in stock to the purchaser. The purchaser may be notified when the item(s) become available or are in stock.

The above steps are depicted in element 602.

In some embodiments, if the purchaser has been recognized by the system, this may conclude the purchasing transaction. The computing system can charge the payment method on file. Alternatively the purchaser may select a checkout feature on the electronic device or scan a checkout indicator. The computer system can complete the transaction by prompting the purchaser for verification of payment information. If the purchaser is a first time purchaser the computer system can ask for payment information and complete the purchase transaction. At block 603, once the transaction is complete the system may inform the purchaser where to pick up purchased items, including, but not limited to the store shelf, pickup counter or designated tote. The item(s) could also be delivered to the purchaser from the service area or shipped to his/her preferred mailing address.

If the purchaser is finished shopping then any loaned electronic device is returned and the purchaser ends his shopping experience. If the purchaser is not finished shopping, then his or her shopping experience can continue by searching the displays for item(s) of interest or by accepting to purchase alternate feature specific items) that are in stock.

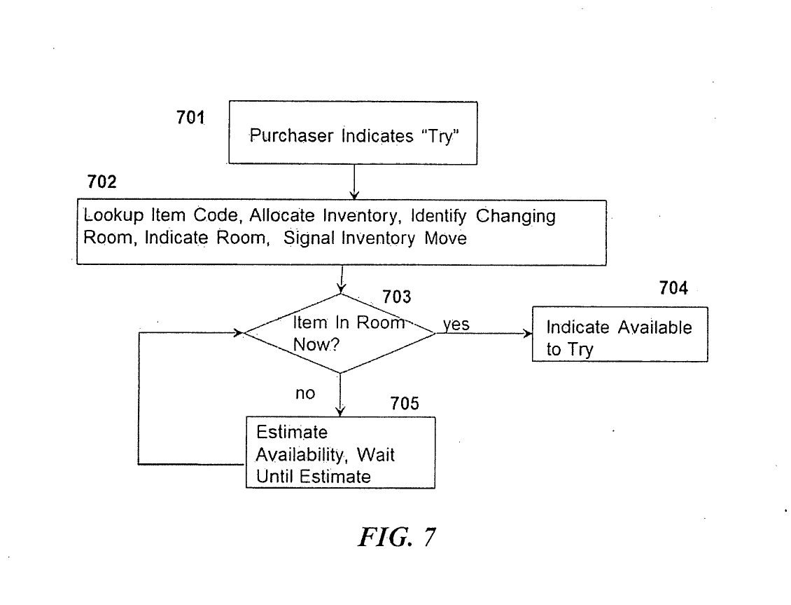

B. Buying with Trying Items On (FIG. 7)

In one embodiment another type of purchaser can prolong the shopping experience beyond the quickest possible experience. This type of purchaser can search the displays and arrive at an item of interest.

At block 701, if the purchaser desires to try on a feature specific item he or she may indicate so. For example, the purchaser may interact with the try indicator, for example, by scanning the try indicator using electronic device. Another way is to move the desired item. Another way it to select to try the desired item using electronic device.

If the purchaser is recognized and has historical purchasing data then this data can be retrieved from the purchasing establishment's computing system. If the purchaser is recognized as a guest purchaser or a first time purchaser, then the electronic device can prompt him or her for more specific features of the item that are desired, such as size, color, etc.

The history of feature specific item(s) that purchasers select to try on can be recorded and preserved in the purchasing establishment's computing system (e.g., system 401 of FIG. 4).

At block 702, once the purchasing establishment's computing system knows that the purchaser wants to try on feature specific item, the computing system can search for the availability of the feature specific item(s) in inventory.

If the feature specific item is not in stock then the electronic device can notify the purchaser that the feature specific item(s) are unavailable or on back order. Alternative feature specific items that are in stock may be suggested to the purchaser. The purchaser may be notified when the item(s) become available or are in stock.

At blocks 703 and 705, if the feature specific item is in stock, the computing system can prompt a reservation of the purchasing establishment's fitting room and communicate to the purchaser (for example, via the electronic device), which of the fitting rooms is reserved for his or her use and whether and how long until the items are ready to try on. The system may also virtually add the feature specific item to an electronic reserve cart (as opposed to a shopping cart). While feature specific items are being virtually added to the electronic reserve cart they can be gathered in the service area.

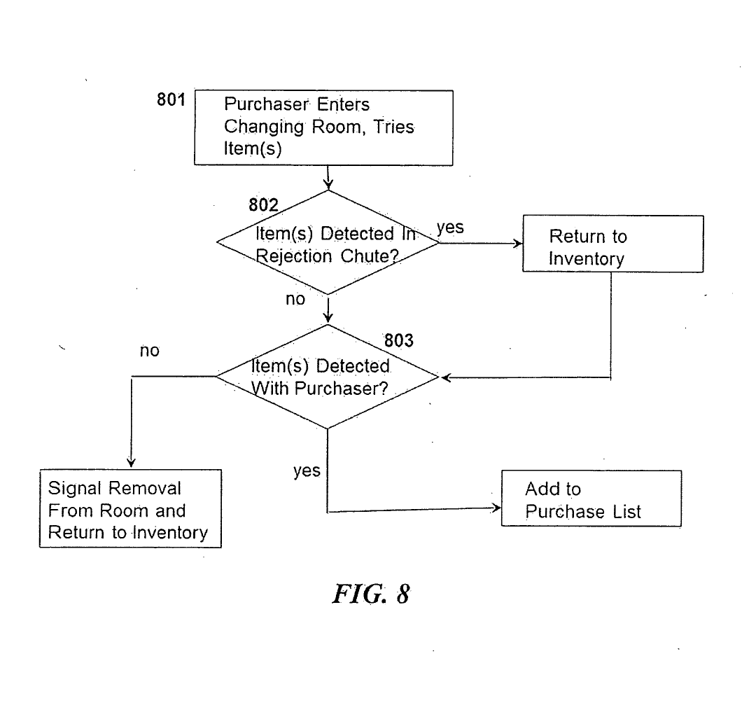

Once the purchaser is finished selecting item(s) to try on, the purchaser may so indicate by entering a vacant changing space or by selecting a feature on the electronic device or by interacting with an indicator. At block 704, if the purchaser uses the electronic device to indicate readiness to try on feature specific items the electronic device can direct the purchaser to one of the purchasing establishment's enclosed changing spaces (element 704). Feature specific items can then be moved from the service area into the changing space reserved for the purchaser. After the purchaser enters the reserved changing space the purchaser may secure their privacy (i.e., lock the door), and try on the feature specific items) to be worn, shown in FIG. 8 block 801.

FIG. 8 is a flow diagram of a routine to implement a purchaser's requests in the fitting room in accordance with an embodiment of the disclosure. At block 802, if the purchaser declines to purchase the feature specific item(s) the purchaser may return the unwanted item(s) through the request window. The establishment computing system may detect unwanted items (for example, from a signal from the array of readers) and virtually remove the item from purchaser's reserve cart. Another way is for the purchaser to leave the unwanted items in the fitting room.

### C. Requesting to Try on a New Feature Specific Item (For Example, Different Size).

If the purchaser desires to select new feature specific items to try on the purchaser may choose to remain in the changing room and continue to browse the purchasing establishment's items on the electronic device and request that those items be brought to the changing room.

Another way is, the purchaser may request a larger or smaller size by placing the item in the corresponding request window. The purchase may also interact with color and/or size indicators inside the fitting room. The requested items may be gathered in the service area and delivered to the purchaser fitting room.

At block 803, the system detects whether the purchaser has kept the item(s). At block 804, if the purchaser decides to purchase the item, the purchaser can simply leave the changing space with the item(s), triggering a zero-action purchase.

The purchaser may also complete the purchasing transaction by interacting with the Checkout indicator or by using Checkout routine on electronic device. Once the purchasing transaction is completed by the computing system, the purchaser may leave the purchasing establishment with the item(s).

The purchaser may also choose to have the feature specific item(s) packaged. Packaging may be performed by the purchaser or by the purchasing establishment. For example, the purchaser may request packaging by placing the item(s) into a Packaging request window.

If the purchaser is finished shopping then any loaned electronic device is returned and the purchaser ends his shopping experience. If the purchaser is not finished, shopping then his or her shopping experience can continue by searching the displays for item(s) of interest or by accepting to purchase alternate feature specific item(s) that are in stock.

### D. Returning Unwanted Items

Each feature specific item that was purchased can have included in or on it an identifier that uniquely identifies the feature specific item (e.g., an RFID or visual code). When a purchaser enters the sensing range of the array of readers the unique identifier can communicate with the purchasing establishments computing system and can identify the item and which account was used to purchase the item. The purchaser then deposits the item to be returned into a return area and leaves. An employee can then examine the garment for conditions that would void eligibility for return. If the garment is eligible for return then the purchasers account can be credited the purchase price.

While the foregoing written description Of the invention enables one of ordinary skill to make and use what is considered presently to be the best mode thereof, those of ordinary skill can understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. An apparel selling system, comprising:
a plurality of apparel items, wherein each apparel item has at least one computer-readable indicator;
an apparel display area, comprising displays of apparel items;
an inventory area, comprising stocked apparel items associated with displayed apparel items,
such that at least one stocked apparel item is associated with a displayed apparel item having a specific apparel-related feature that is different from the stocked apparel item; and
a computing device configured to:
read indicators of apparel items; and
transmit a selection of an indicator thereby causing an apparel item corresponding to the selection to be retrieved from the inventory area and placed in a changing space.

2. The apparel selling system of claim 1 wherein each displayed apparel item having an indicator comprises each displayed apparel item having a purchase indicator, a try indicator, and an information indicator.

3. The apparel selling system of claim 1 wherein a computer-readable indicator is an RFID tag.

4. The apparel selling system of claim 1 wherein a computer-readable indicator is a two-dimensional barcode.

5. The apparel selling system of claim 1 wherein a computing device configured to read indicators of apparel items comprises an application on a mobile computing device.

6. The apparel selling system of claim 1 wherein a computing device configured to read indicators of apparel items comprises a scanning device.

7. The apparel selling system of claim 1 wherein transmitting a selection of an indicator comprises transmitting the indicator and an action relating to the indicator.

8. The apparel selling system of claim 1 wherein an action relating to the indicator is a purchase request.

9. The apparel selling, system of claim 1 wherein transmitting a selection of an indicator comprises transmitting a request from a particular customer to try on a selected apparel item.

10. A method of selling apparel, comprising:
displaying apparel items, each apparel item having an associated computer-readable indicator;
receiving, via a transmission identifying a computer-readable indicator, a selection of an apparel item for a customer;
obtaining specific apparel-related feature preference information for the customer;
determining whether a selected apparel item matching the customer's specific apparel-related feature preferences is in stock; and
if a selected apparel item matching the customer's specific apparel-related feature preferences is in stock, causing to be deposited to a changing space a matching selected apparel item.

11. The method of claim 10, further comprising, if a selected apparel item matching the customer's specific apparel-related feature preferences is not in stock, suggesting alternative apparel items for customer selection.

12. The method of claim 10, further comprising, if a selected apparel item matching the customer's specific apparel-related feature preferences is not in stock, offering to deliver the selected apparel item to the customer.

13. The method of claim 10, further comprising providing a computer-readable indicator reader to a customer.

14. . The method of claim 10, wherein providing .a computer-readable indicator reader to a customer comprises providing an application for a mobile computing device.

15. The method of claim 10, further comprising directing the customer to a fitting room.

16. The method of claim 15, further comprising indicating when the selected apparel item is ready for the customer.

17. The method of claim 10, further comprising:
detecting a customer taking an apparel item; and
treating the customer's taking the apparel item as a consummated purchase, such that no additional customer action is required to purchase the apparel item.

18. A method of selling apparel, comprising:
associating a computer-readable identifier with each of a plurality of apparel items;
providing a changing space for a customer to try the apparel items; and
receiving a customer selection of an action regarding each apparel item.

19. The method of claim 18 wherein receiving a customer selection of an action regarding each apparel item comprises determining, for each apparel item, that the customer does not want the item; wants, an item with different specific apparel-related features; or wants to purchase the item.

20. The method of claim 19 wherein wanting an item with different specific apparel-related features comprises wanting a larger or smaller item.

21. The method of claim 18 wherein receiving a customer selection of an action regarding each apparel item comprises detecting an apparel item in a designated location.

22. The method of claim 21 wherein detecting an apparel item in a designated location comprises detecting an apparel item in a discard chute.

23. The method of claim 18 wherein receiving a customer selection of an action regarding each apparel item comprises detecting a customer taking an apparel item from the changing space.
